(19) United States
(12) Patent Application Publication
(10) Pub. No.: US 2016/0019291 A1
(43) Pub. Date: Jan. 21, 2016

(54) Apparatus And Method For Information Retrieval At A Mobile Device

(71) Applicant: John R. Ruge, Chicago, IL (US)

(72) Inventor: John R. Ruge, Chicago, IL (US)

(21) Appl. No.: 14/335,408

(22) Filed: Jul. 18, 2014

(51) Int. Cl. G06F 17/30

(52) U.S. Cl. CPC G06F 17/30678; G06F 17/30864; G06F 17/3043; G06F 17/30058

(57) ABSTRACT

A topic selection from a user is obtained. The topic selection obtained via user action at a user interface of a mobile device. Based upon the topic selection, one or more questions are retrieved. Each of the questions being linked to an optimized search stored in a memory of the mobile device. A question selection from the user is received. The optimized search is retrieved from memory based upon the question selection of the user. Search results accomplished by the search are received and presented to the user. The search results can be saved for further analysis. The topic and question selections can be saved as a favorite for future use. Also, a handbook with chapters can be provided to display formatted results and is updated each time visited by a user.

### TECHNICAL FIELD

The present disclosure relates to information retrieval and, more specifically, to information retrieval from mobile devices.

### BACKGROUND OF THE INVENTION

Prior to the Internet, physicians searched for new medical treatments, procedures, clinical information or other needed information by consulting printed materials, such as journals or textbooks, or attending medical conferences. In medicine, information changes rapidly, and therefore, printed materials can become outdated quickly, including journals even though they have shorter publication cycles. Upcoming conferences also may not meet the current informational needs of the physician because the topics may not address the situation facing the physician.

Because of the limitations of printed materials and conferences, physicians now turn to the Internet to assist them with their informational needs. However, searching the Internet can be frustrating for some. For instance, some physicians may not find the information they are looking for because they may not be using good search techniques, which would include knowing how to formulate searches and what sites to search. This may lead them to not use the Internet. Other dissatisfactions stem from shortcomings with conventional search engines in processing medical-related inquiries. For instance, these search engines often return results with highly marketed sites that have been optimized by heavycross-linking at the top of the results. Thus, the more cross-linked sites are often not the ones with the more valuable information. If relevant information is eventually identified, it commonly happens after several search attempts and many hours of reviewing the search results. Even then, no mechanism exists to store it in an easily retrievable format for future use or analysis. Finally, there is no efficient and effective way to search remotely, such as with a smartphone. It is difficult to sift through large amounts of information using a mobile search device.

All of these shortcomings have led to a general dissatisfaction with using the Internet to perform efficient and effective targeted searching. While the foregoing references the medical field, these shortcomings are not limited to this field and are present in a vast number of fields and professions, especially those with fast changing information.

### BRIEF DESCRIPTION OF THE DRAWINGS

FIG. 1 comprises a flow chart showing one approach for information retrieval from a mobile device according to various embodiments of the present invention;

FIG. 2 comprises a flow chart showing one approach for information retrieval from a mobile device according to various embodiments of the present invention;

FIG. 3 comprises a block diagram of a data structure according to various embodiments of the present invention;

FIG. 4 comprises a block diagram of a mobile device according to various embodiments of the present invention;

FIG. 5 comprises a block diagram of various screens showing results according to various embodiments of the present invention;

FIG. 6 comprises a flow chart showing one approach for information retrieval from a mobile device involving medical applications according to various embodiments of the present invention;

FIG. 7 comprises a screen shot of one example of a topic screen according to various embodiments of the present invention;

FIG. 8 comprises a screen shot of one example of a question screen according to various embodiments of the present invention;

FIG. 9 comprises a screen shot of one example of a results screen according to various embodiments of the present invention;

FIG. 10 comprises a block diagram showing one example of a search according to various embodiments of the present invention; and

FIG. 11 comprises a block diagram showing one example of a live book according to various embodiments of the present invention.

### DETAILED DESCRIPTION OF THE INVENTION

The approaches described herein utilize applications deployed on mobile devices, such as smartphones, cellular phones, and tablets, and personal computers. The approaches are efficient and effective tools for obtaining highly relevant information.

In one example, there is provided an approach for the retrieval, organization, and storage of relevant medical information related to cancerous tumors. The relevant information is rapidly acquired from the Internet using enhanced search strings. The information can then be stored in an easily retrievable format, emailed, and/or printed. The information also can be presented in any form or format, such as in a textual format, an image, or a video to mention a few.

In other aspects, the approaches create a “live book” for any topic (not just cancer) where the user chooses the topic and the web/mobile application then refreshes embedded searches to generate a unique (i.e., always new with each use) “book” on the chosen topic. The application facilitates the creation of a library of articles, images and videos of particular interest and value. For example, a continually updated reference manual for the medical practitioner in a particular field can be created using this application.

These approaches reduce and even eliminate the frustrations associated with existing search engines and techniques looking to find specific and targeted information. The application automatically presents topics and questions for selection and, then, automatically performs the search and presents the results to the user at a mobile device. The user is not required to have special knowledge of search engine preferences or honed Internet searching skills in order to quickly find relevant material.

To take one example involving cancerous tumors, experience teaches that the questions asked are often the same as between users regardless of the type of tumor. From another view, although the information is changes quickly, the questions typically remained the same. The present approaches focuses on identifying the questions and then optimizing the searching based on the questions. This has been found to retrieve very useful results quickly.

Once the questions are identified, they may be included and stored as a list. Each question is then embedded (or the list is embedded) in the memory of the mobile device. The user selects the question, for example, about the specific tumor type or procedure of interest. An optimized search is performed, and the results of the search are displayed automatically and dynamically in a useable, user-friendly format, such as a list.

The approaches here are more efficient and effective at retrieving relevant medical information from the Internet than previous approaches for several reasons. For instance, the embedded search queries have been optimized using appropriate techniques, such as best Boolean search strings (where the search string is vetted so as to yield the optimal results). Consequently, trial-and-error techniques of previous approaches are avoided.

Other advantages include using only pre-selected, vetted websites for searching. In addition to text, images and videos also are located and included in the search results. The addition of images and videos provides more useful and enhanced search results over conventional techniques that provided text only.

For some situations, the application can be designed with a very narrow focus (e.g., cancer based). In this case, the questions are very directed and specific to find relevant and targeted results. For example, if the application relates to cancer, the questions are designed and selected by doctors and experts in oncology.

In another aspect, embedded questions are trended to allow the application to grow and provide even more relevant results over time. In one example, the order of questions presented to a user changes over time so that the questions that users are actually using are provided to the user in order of priority. The change can occur automatically using predetermined criteria, such as statistical analysis where a preset threshold of a lower listed question is being used more than a higher listed question.

A number of approaches for information retrieval from a mobile device are described. Although the approaches are particularly advantageous when executed using a mobile device, it will be appreciated that these approaches may be performed or created at any location or device, regardless of whether the device is mobile or not. Further, even though many examples described herein relate to medical topics (e.g., cancerous tumors), it will be understood that the approaches are not limited to this field and can be extended to other fields and professions.

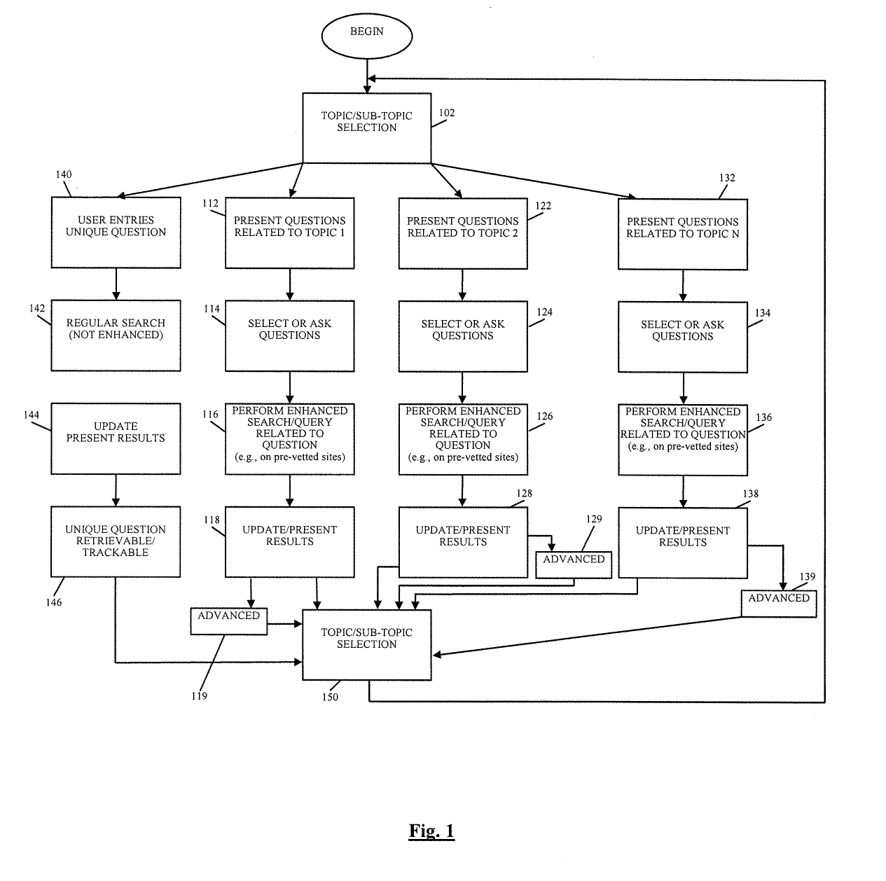

With reference to FIG. 1, step 102 references selecting a topic and/or sub-topic. This step 102 may present several screens to the user to allow the selection. For example, a user may select a topic from a topic screen, and this selection may lead to other sub-topic screens where a sub-topic list is presented to the user for selecting a sub-topic.

Depending on the topic, various sequences of steps may be executed. For example, steps 112-118 are executed if topic 1 is chosen; steps 122-128 are executed if topic 2 is chosen; and steps 132-138 are executed if topic “n” is chosen. Additionally, steps 140-146 are executed if a user elects to enter their own question, rather than view a list of vetted, embedded questions. The topics may relate to any item information, but in one example relate to different types of cancerous tumors. Other examples of topics are possible.

At steps 112, 122, or 132, questions related to a particular topic are presented to the user. They are presented on a user interface (e.g., a graphical display). In one situation, the questions may be presented as icons. At steps 114, 124, or 134, a question selection is made such as by tapping the icon on the screen. Other selection approaches are possible. By selecting the question, a search is executed by the application at steps 116, 126, or 136.

An enhanced type searching related to the question is performed. In one aspect, enhanced searching refers to using search queries that are optimized in advance by the application provider. This optimization may employ expertise in the particular field being searched as noted above. The application provider optimizes the searches, for example, by actually testing different search queries (e.g., which may take the form of a Boolean search string) for the same question in order to determine which search query generates the best results. The application provider may further choose which websites are to be searched, further optimizing search results.

A Boolean search string is typically the format used by search engines to generate search results. Quotation marks, parenthesis, and Boolean terms such as “and,” “or,” “near,” and “not,” as well as combinations of these terms can be used to optimize search results. For example, where A, B, and C are search terms, the search string (A and (B or C) may be an optimized search that is the best search associated with a particular question as opposed to A and B and C.

At steps 118, 128, or 138, search results are presented to the user. For example, the search results may be presented at a graphical user interface (e.g., a touch screen) of a mobile device.

At steps 119, 129, or 139, an advanced search may be initiated. The advanced search feature allows the enhanced search to be further refined. For instance, in the advanced search, additional modifying terms may be used to refine or filter the results of the enhanced search string.

As mentioned, the user can optionally enter their own questions rather than use the pre-vetted questions. In these regards, step 140 refers to where the user can enter a question not on the pre-vetted list. At step 142, an unenhanced search may be performed using the question of step 140. At this step, any search engine (e.g., Google) can be used with the search terms merely inserted as a string of terms.

At step 144, if the application provider determines that a sufficient number of users are asking the same new question, then this new question can be enhanced and added to the embedded enhanced list. At step 146, the new question is retrievable and tracked by the application provider to enable this analysis.

At step 150, questions may be updated or order of questions changed. For example, questions that the user entered may be added to the embedded enhanced list. The order of the questions also may be changed based upon the popularity of the questions selected by various users. For example, the more popular questions may be ordered higher in the list compared to other, less popular questions.

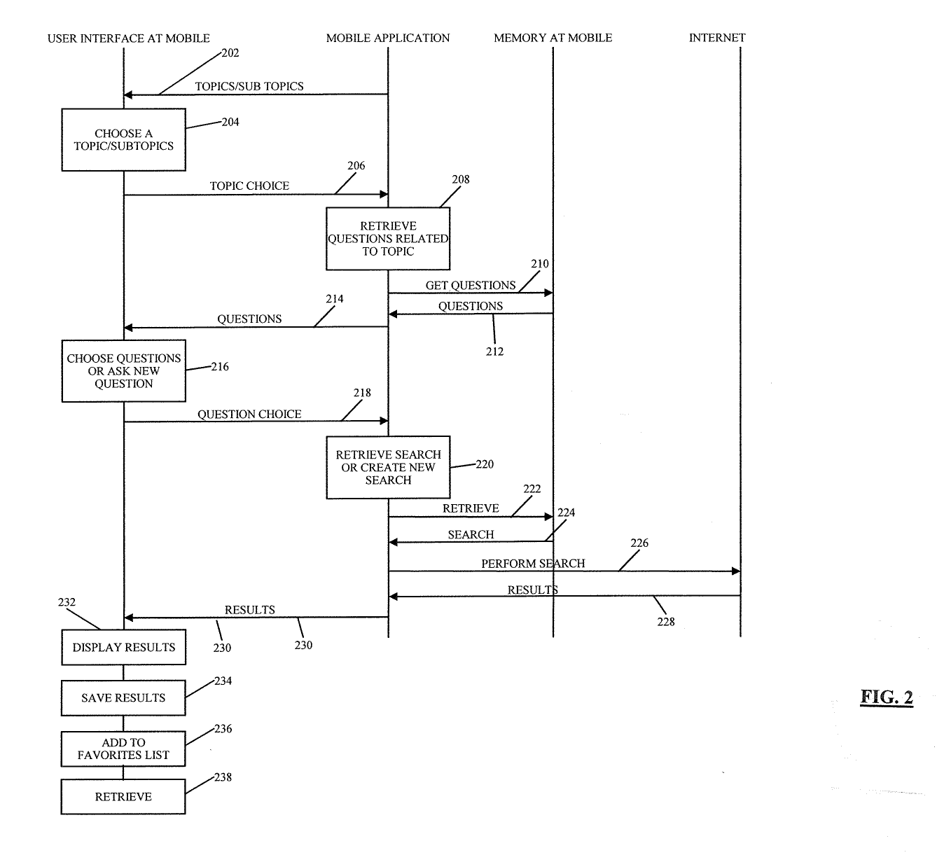

Referring now to FIG. 2, one example of an approach for information retrieval from a mobile device is described. FIG. 2 shows the occurrence of events and the flow of information at and between the interface (e.g., screen) of the mobile device, the mobile application, the memory at the mobile device, and the Internet. The mobile application may be executed at a mobile device such as a cellular phone, tablet, personal computer, or a personal digital assistant to mention a few examples. Other examples of mobile devices are possible.

At step 202, a topic/subtopics list is sent from the mobile application to the user interface (screen) for presentation to a user. For example, for a cancer tumor application, a list of all tumor types may be sent to the user interface.

At step 204, the user selects a topic. For a tumor-searching application, the user may select a tumor name from the tumor list. For example, the user may tap an icon on their screen to make the selection.

At step 206, the topic choice is sent to the application. For instance, and continuing to use the preceding example, the name of the selected tumor is sent to the application.

At step 208, the mobile application forms commands to retrieve a question list from memory. The question list retrieved relates to the selected topic. More specifically, the question list is pre-vetted, for example, by an application provider to provide the most relevant questions related to a topic.

At step 210, commands are sent to the memory of the mobile device to obtain the questions or question list. At step 212, the questions or question list are retrieved from memory. At step 214, the questions or question list are sent to the user interface for presentation to the user.

At step 216, the user chooses the question using the user interface. The user may, for instance, tap an icon on the display of their mobile device. At step 218, the question choice selected by the user is forwarded to the application.

At step 220, the application executes steps to retrieve the search or create a new search where none exists. For example, the application may form commands to retrieve the enhanced search associated with the question from the memory. At step 222, commands are sent to retrieve the search.

At step 224, the enhanced search associated with the selected question is retrieved from the memory. At step 226, the search is executed. In these regards, commands may be sent to the Internet to obtain appropriate information. At step 228, the Internet sends the search results to the mobile application. At step 230, the mobile application sends the search results to the user interface for presentation to the user.

At step 232, the search results are displayed. For example, the results are displayed on the graphical user interface of the user so that the user can peruse them. The search results may themselves have embedded links (e.g., hypertext links). The user can then select the appropriate link (e.g., by tapping the link), and the application will allow the web page associated with the link to be presented to the user.

At step 234, the search results can be saved, for example, in the memory of the mobile device or printed. At step 236, the user can optionally add the topic selection and question selection to a favorites list. The favorites list can be recalled at a future time and the topic and its related search can be easily retrieved without the user having to go through the various selection steps. At step 238, the user can retrieve previous selections/searches that are stored in memory.

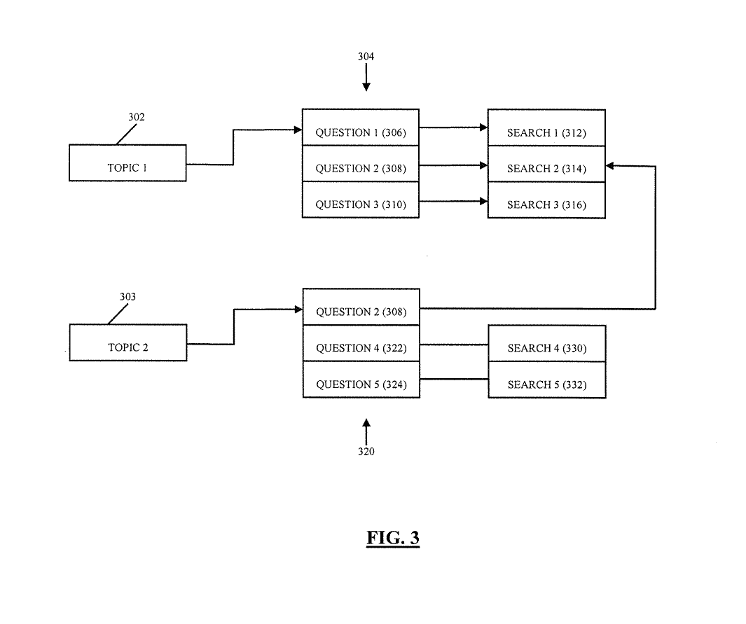

Referring now to FIG. 3, a data structure showing relationship of questions and searches will be described. It is to be appreciated that this is one representation of a data structure and that other data structures are possible. Also, the data structure can be programmed according to a number of know programming languages.

A first topic 302 (Topic 1) points to (or indicates) a first list of questions 304. Each question (e.g., a first question 306, a second question 308, and a third question 310) points to (or indicates) an enhanced search. More specifically, the first question points to (or indicates) a first enhanced search 312, the second question 308 points to (or indicates) a second enhanced search 314, and the third question 310 points to (or indicates) a third enhanced search 316. As discussed above, each of the searches 312, 314, and 316 are predetermined strings of search terms that are organized and/or optimized using Boolean operators/constructs to achieve the best search results.

A second topic 303 (Topic 2) points to (or indicates) a second list of questions 320. Each question (a second question 308 (the same as in the first list), a fourth question 322, and a fifth question 324) points to (or indicates) a search. More specifically, the second question 308 points to (or indicates) the second search 314, the fourth question 322 points to (or indicates) a fourth search 330, and the fifth question 324 points to (or indicates) the fifth search 332. Each of the searches 314, 330, and 332 are predetermined strings of search terms that are organized or optimized using Boolean operators/constructs to achieve the best search results.

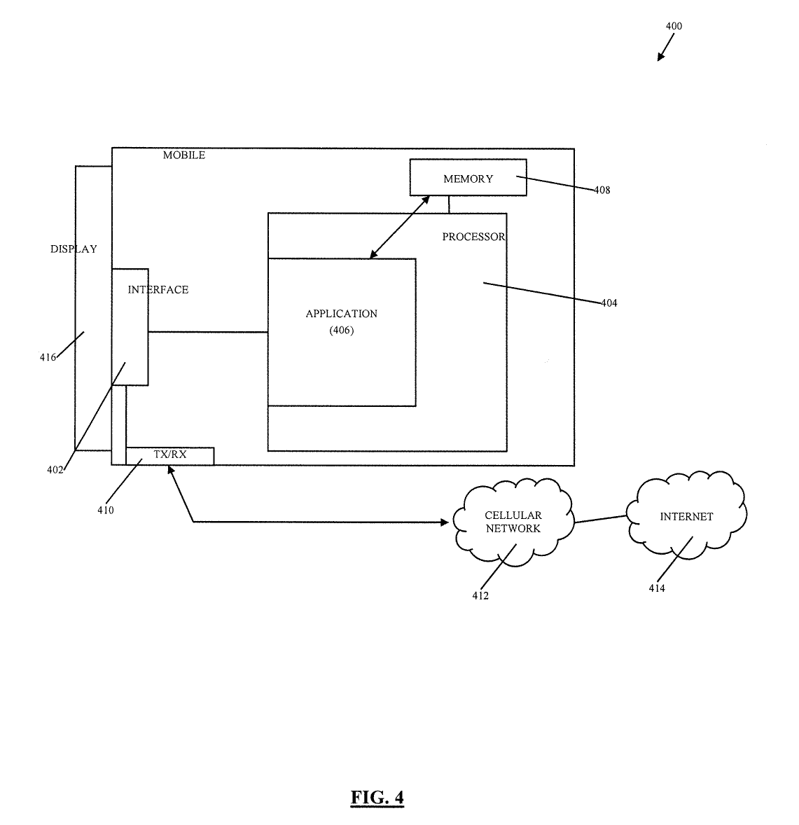

Referring now to FIG. 4, one example of a mobile device 400 that runs an application is described. The mobile device may be a cellular phone, smartphone, tablet, personal computer, or a personal digital assistant to mention a few examples. Other examples of mobile devices are possible, including those dedicated primarily to the function of these approaches.

The mobile device 400 includes an interface 402, a processor 404 that runs an application 406, a memory 408, a display 416, and a transmitter/receiver 410. The device 400 communicates with the internet 414 through a network 412.

The interface 402 provides a hardware and/or software interface between the display 416, the processor 404 and the transmitter/receiver 410. The processor 404 is any appropriate processing device (such as a microprocessor), and the memory is any type of computer memory. The application 406 manages information needed by the user to select topics and questions, retrieves searches, transmits search requests to search engines to perform searches, and performs other functions described herein.

The transmitter/receiver 410 transmits and receives information from the cellular network 412. In these regards, it is to be appreciated that the network 412 may be any combination of any type of networks, such as cellular networks, Ethernet compatible networks, local area networks, or wide area networks, wifi enabled networks to mention a few examples.

The Internet 414 is the world-wide web having various gateways, routers, and servers. The display 416 is any graphical user interface and may be a screen, touch screen, key pad, computer mouse, or any combination of these or other elements that allow a user to communicate or receive information from the mobile device 400.

In one example of the operation of the mobile device 400, a topic selection from a user is obtained, from a user indicating the topic at the display 416. For instance, the display 416 may be a touch screen, which the user touches to choose a topic. In another example, the display 416 may have an associated keyboard where the user types in information to indicate a topic selection.

Based upon the topic selection, one or more questions (e.g., in the form of a question list) are retrieved from the memory 408 of the mobile device 400. Each of the questions on the list has been linked to an optimized search, and this linkage also is stored or embedded in the memory 408. Each optimized search further is stored or embedded in the memory 408. The display 416 may be a touch screen, which the user touches to choose a question on the list. In another example, the display 416 may have an associated keyboard that the user uses to navigate the display or others types in information to indicate a question selection. The questions (or question list), enhanced searches, and linkage between the questions and the searches may be downloaded from an application provider at appropriate times. These also may be updated automatically or manually on the mobile device from the application provider.

The optimized search is retrieved from the memory 408 based upon the question selection of the user. A search may be sent via transmitter/receiver 410 to the cellular network 412 and the Internet 414. Search results accomplished by the search at the Internet 414 are received at the transmitter/receiver 410 and presented to the user at the display 416 via the interface 402.

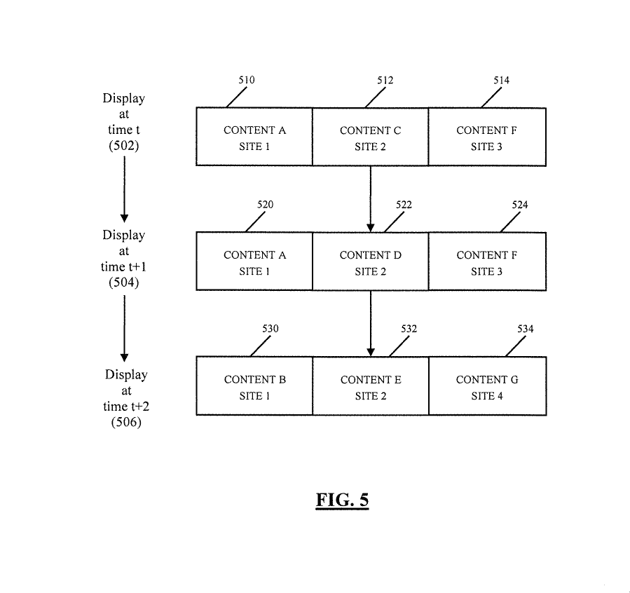

Referring now to FIG. 5, various examples of displays that can be presented to users are described. A first display 502 is presented at time t, a second display 504 is presented at time t+1, and a third display 506 is presented at time t+2. FIG. 5 illustrates the dynamic and changing nature of search results that are presented to a user. That is, as time changes, different search results with different contents and from different websites may be presented to users.

The first display 502 includes a first content 510 (Content A, website 1), a second content 512 (Content C, website 2), and a third content 514 (Content F, website 3). Subsequently, when the second display 504 is made, it includes a first content 520 (Content A, website 1), a second content 522 (Content D, website 2), and a third content 524 (Content F, website 3). Thus, the content presented from website 2 has changed from time t to time t+1. It is to be understood that Content A differs from Content B, Content B differs from Content C, and so forth.

Subsequently, when the third display 506 is made, it includes a first content 530 (Content B, website 1), a second content 532 (Content E, website 2), and a third content 534 (Content G, website 4). Thus, the content from website 1 has changed, the content of website 2 has changed again, and website 3 has been replaced with website 4 having a new and different content.

Thus, the present approaches can be used to create a “live book” for any topic (not just cancer) where the user chooses the topic and the web/mobile application then refreshes embedded searches to generate a unique (i.e., always new with each use) “book” on that topic. The live book is digital book with electronically displayed organized units of text, images and videos. It is organized around a particular topic that is constructed with embedded searches. The live book also can be refreshed in the future to be updated as explained further below. The live book could then be printed if desired. As can be seen in the example above, each display may be considered presentation of the live book, and the content of that live book changes over time. It is to be appreciated that the application can automatically update the book with no user intervention. Alternatively, the user could initiate a refresh of the book as desired.

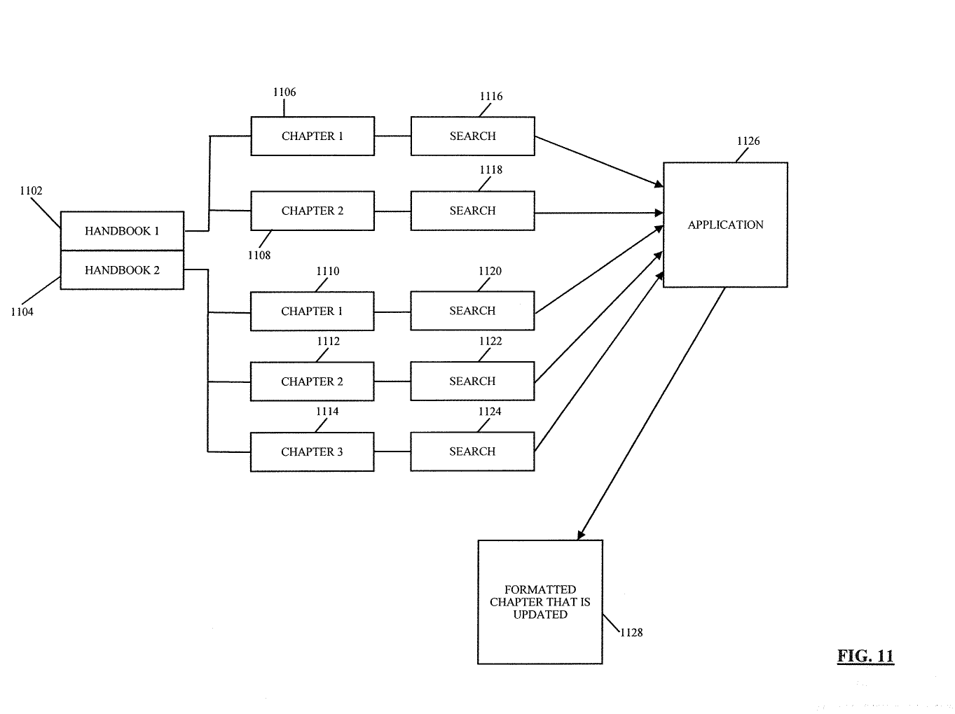

In one particular example of a “live book” and now referring to FIG. 11, a live book data structure (e.g., stored at a memory at the user's mobile device) includes a hand book list that includes a first hand book 1102 and a second hand book 1104. The first hand book 1102 points to (or indicates) a chapter list that includes chapters 1106 and 1108. The chapters 1106 and 1108 point to (or indicate) embedded searches 1116 and 1118, respectively. The second hand book 1104 points to (or indicates) a chapter list that includes chapters 1110, 1112, and 1114. The chapters 1110, 1112, and 1114 point to (or indicate) embedded searches 1120, 1122, and 1124, respectively. The searches may be implemented as Boolean search strings and selected according to the approaches described elsewhere herein.

An application 1126 operating on a mobile device receives a handbook and chapter selection from a user. The application 1126 automatically performs the embedded search associated with a particular chapter, formats the results into an appropriate format, and presents the formatted and updated chapter 1128 to the user. The format can take a form like text of a book, including with pictures, images and video. It also could have citations and footnotes. The citations and footnotes can be presented as hypertext links. The user can then view the chapter on an appropriate interface such as the touch screen of their mobile device.

In this way, a particular chapter or (or group of chapters or an entire book) is automatically and dynamically updated by an application using the embedded and optimized searches that are described herein. A particular handbook or book is always current and updated every time a user wishes to access and read the book (or portion of the book). The updated information is presented and rendered to the user as requested by the user, rather than continuously thereby saving power and processor bandwidth at the user's mobile device.

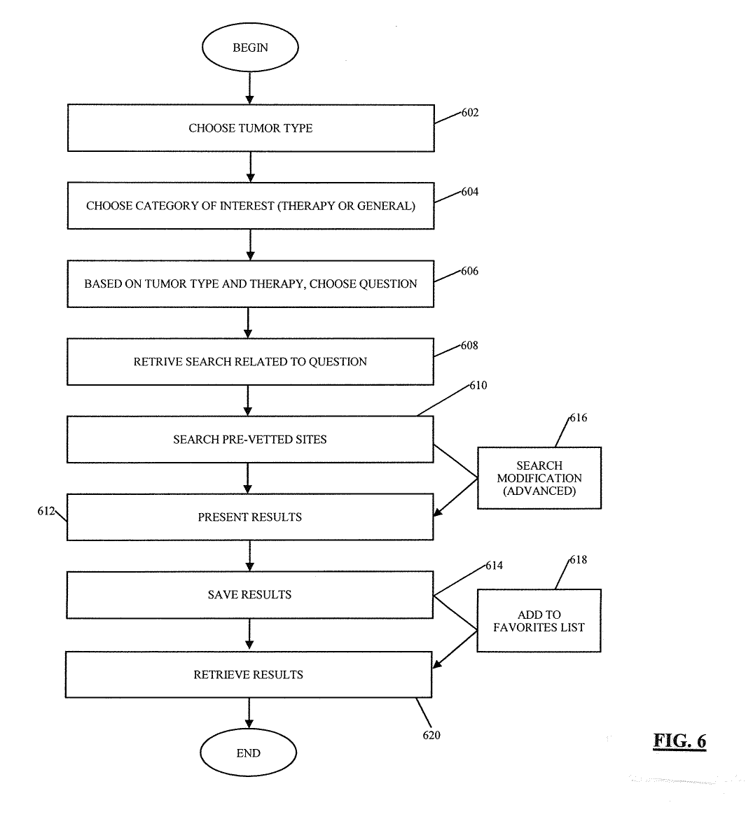

Referring now to FIG. 6, one example of an approach for information retrieval from a mobile device in a medical field is described. It is to be appreciated that this is one example of an approach related to the retrieval of medical information and that other examples are possible in this field as well as many other fields.

At step 602, a tumor type is selected. For example, for a list of tumor types beginning with the letter “a,” “anaplastic astrocytoma” may be selected. At step 604, a category of interest is selected (e.g., therapy or general). This selection may be further used to narrow the questions that are presented to the user.

At step 606, a question is selected. The question is a pre-vetted question, and the questions on the list may be ordered based, for instance, on popularity amongst users.

At step 608, a search related to the question is retrieved. More specifically, each question has an associated enhanced search. As mentioned previously, the search may be optimized by the application provider (or potentially others) using Boolean constructs to achieve the best results. In these regards, the application provider performs tests with various search strings, analyzes the test results (to determine which search string structure yields the best results), and chooses the search string structure that achieved the best results. A linkage between the search string and the question also is established by the application provider.

At step 610, the search is made at pre-vetted sites. For example, some websites may not have useful information, may include erroneous information, or may be commercial sites only interested in selling products or services to users. Consequently, in order to optimize search results, these undesired sites may be ignored and not searched while other sites known to have relevant information will be included in the optimized search.

At step 612, the search results are presented to a user. For example, the search results may be presented at a graphical user interface on a mobile device.

At step 614, the search results can be saved. For example, the search results may be saved locally in the memory of the mobile device for future analysis. The results also may be uploaded to a network (e.g., a cloud network) for future retrieval and analysis by the user.

At step 616, optionally the search can be modified by using the advanced search option. By this option, further modifications to the search are allowed and made. For example, the search can be modified according to relevance or date and rank the results based upon these criteria. In one example, the modifications can narrow the search based upon age of the patient and the location in the nervous system of the tumor. Other refinements of known nature are contemplated in these approaches.

At step 618, the user can optionally add the topic selection and question selection to a favorites list. The favorites list can be recalled at a future time and the topic and its related search can be easily retrieved without the user having to go through the various selection steps. At step 620, the user can retrieve previous selections/searches that are stored in memory.

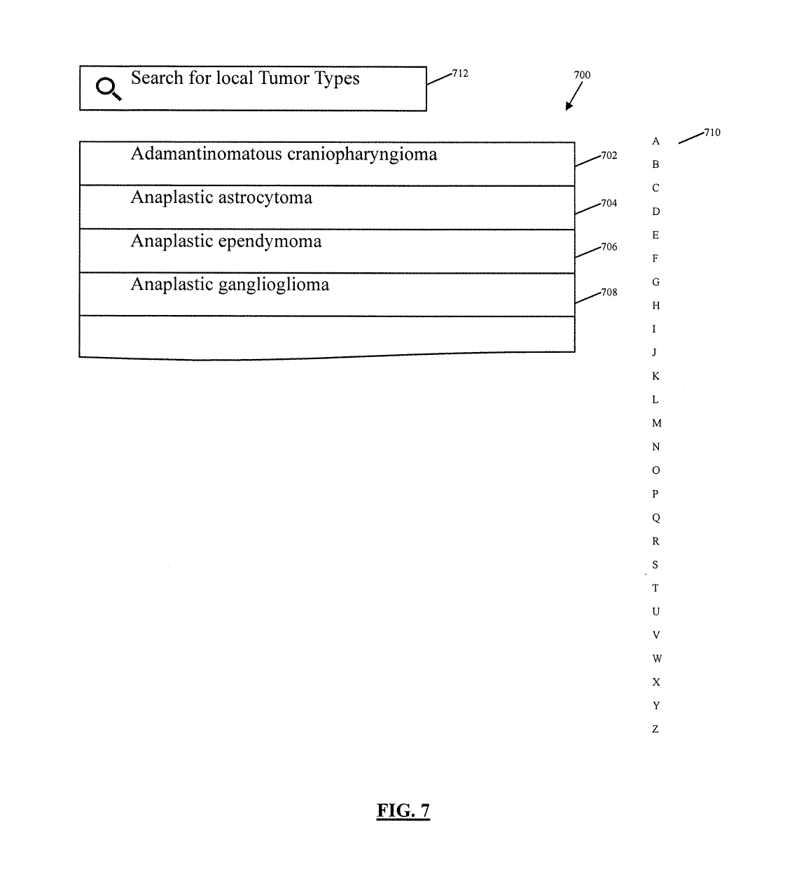

With reference to FIGS. 7-9, examples of screen shots showing results of searches are described. FIG. 7 shows one example of an initial topic screen 700 that is presented to a user. The screen 700 shows topics 702, 704, 705, and 708. Alphabetical lookup area 710 allows a user to click on any of the letters to find tumor types beginning with a particular letter. A search box 712 additionally allows a user to search for a tumor type by directly entering the name of the tumor in the search box 712 to determine if the tumor is included as a covered topic.

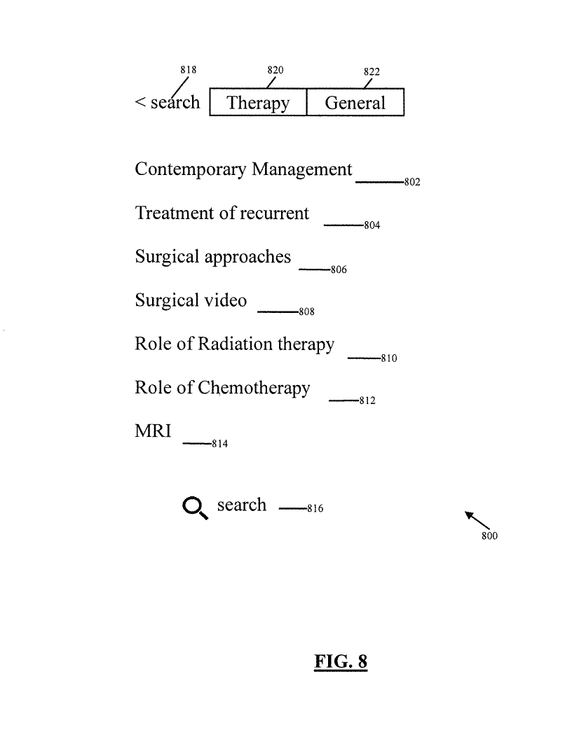

FIG. 8 shows a questions screen 800 that is presented to the user when the “anaplastic astrocytoma” topic (indicated by label 704) in FIG. 7 is selected. The screen 800 includes questions 802, 804, 806, 808, 810, 812, and 814. The screen 800 also allows a search to be made via a box 816 or a return to the topic screen by selection of an icon 818. Additionally, the screen 800 allows selection of questions based upon a therapy (represented by icon 820) or general questions (represented by an icon 822).

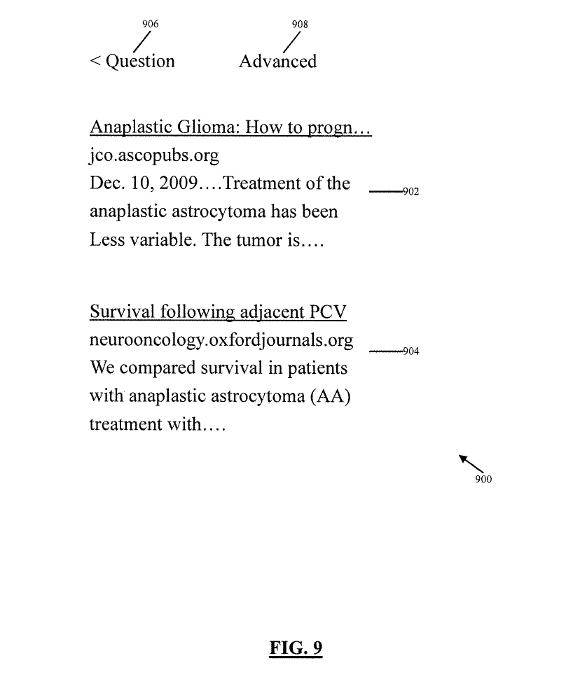

FIG. 9 shows the results screen 900 when the “treatment of recurrent” element 804 of FIG. 8 is selected. The “treatment of recurrent” question has an enhanced search associated with it, and FIG. 9 shows the results of performing that search. In these regards, the screen 900 includes search results 902 and 904. An icon 906 allows a user to return to the questions screen 800 of FIG. 8. Advanced button 908 allows a user to perform an advanced search as described above. Search results also may include hypertext links, which may be selected by a user to take the user to the website associated with the hypertext link.

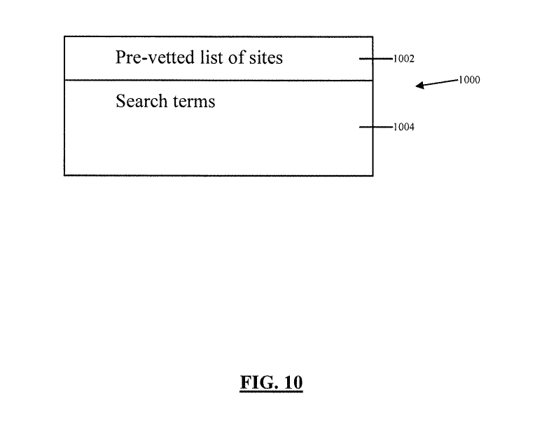

Referring now to FIG. 10, one example of a search 1000 is shown. The search 1000 includes a list of pre-vetted sites 1002 that will be searched. The search includes a list of search terms 1004, for example, organized as a search string. In one aspect, searches are optimized by the application provider. The application provider optimizes with Boolean structures, for example, by actually testing different search queries for the same question in order to determine what structure generates the best results. The application provider also chooses which websites are to be searched, further optimizing search results.

A Boolean search string is a format used by search engines and Internet searches to generate search results. Quotation marks, parenthesis, and Boolean terms such as “and,” “or,” “near,” and “not,” as well as combinations of these structures, can be used to optimize search results.

In one example, a physician user may seek information concerning an anaplastic astrocytoma tumor. It has been found that the search string “treatment of recurrent anaplastic astrocytoma” typically generates sub-optimal results. However, if the search string is “treatment and “recurrent anaplastic astrocytoma,” it has been found that the search results are more relevant and useful. Even better results are typically obtained at specialized sites because the web sites searched are specific to a particular topic (e.g., brain tumor therapy).

The application provider can track very specific usage of the application, and the question list can be optimized. For example, questions that are rarely searched can be eliminated. The most frequent questions used can be listed first. Questions added by the user can be optimized and included in the systems' list. The application provider may utilize specialists in search engine result optimization and/or the particular field of interest so that the search string structure is optimal and the websites are properly selected. Searches can be further revised by the application provider with user feedback.

As mentioned, the present approaches provide multiple advantages. In one advantage, and with respect to medical information, rapid, efficient, relevant medical search results are achieved. The present approaches also provide universal search capabilities (e.g., for text, images, video), as well as mobile device access for these searches. The present approaches provide the ability to email or print results, and improve dissemination of medical information thus improving medical care. Furthermore, the present approaches provide cost reduction in medical care due to time saved.

As mentioned above, these approaches can be used in other fields of interest beyond the medical fields. For example, other fields could include accounting, legal, equipment repair, software, and sports just to name a few.

Preferred embodiments of this invention are described herein, including the best mode known to the inventors for carrying out the invention. It is to be understood that the illustrated embodiments are exemplary only and should not be taken as limiting the scope of the invention.

What is claimed is:

1. A method of retrieving and presenting information to a user at a mobile device, the method comprising:
obtaining a topic selection from a user, the topic selection obtained via user action at a user interface of a mobile device;
based upon the topic selection, retrieving one or more questions, each of the questions being linked to an optimized search stored in a memory of the mobile device;
receiving a question selection from the user;
retrieving from the memory the optimized search based upon the question selection of the user; and
receiving search results accomplished by the search and presenting the search results to the user.

2. The method of claim 1, further comprising accepting user input indicating a new question.

3. The method of claim 1, further comprising ordering the questions based upon a predetermined criteria.

4. The method of claim 1, wherein the search results comprise images or videos.

5. The method of claim 1, wherein the search is optimized according to a best Boolean search approach.

6. The method of claim 1, wherein obtaining a topic selection comprises obtaining multiple topics and sub-topics.

7. The method of claim 1, further comprising storing the search results.

8. The method of claim 7, further comprising retrieving the stored search results.

9. The method of claim 1, wherein the topic selection and question selection are saved on a favorites list.

10. A method of retrieving and presenting information to a user at a mobile device, the method comprising:
providing an application at the mobile device, in the memory of the mobile device being stored a plurality of embedded questions, a plurality of optimized searches selectively linked to the embedded questions, and a plurality of limited websites used by the optimized searches for searching;
obtaining a topic selection from a user, the topic selection obtained via user action at a user interface of the mobile device;
based upon the topic selection, retrieving one or more of the embedded questions;
receiving a question from the user selected from the retrieved one or more of the embedded questions;
retrieving from the memory the optimized search based upon the question selected by the user;
receiving search results accomplished by the optimized search through the plurality of limited websites; and
presenting the search results to the user.

11. The method of claim 10, further comprising accepting user input indicating a new question.

12. The method of claim 10, further comprising ordering the questions based upon a predetermined criteria.

13. The method of claim 10, wherein the search results comprise images or videos.

14. The method of claim 10, wherein the search is optimized according to a best Boolean search approach.

15. The method of claim 10, wherein obtaining a topic selection comprises obtaining multiple topics and sub-topics.

16. The method of claim 10, further comprising storing the search results.

17. The method of claim 16, further comprising retrieving the stored search results.

18. The method of claim 10, wherein the topic selection and question selection are saved on a favorites list.

19. A method of creating an optimized search, the method comprising:
creating a list of questions related to a topic;
for each of the questions, forming at least one computer-based search, each search comprising a Boolean search string;
performing each of the computer-based searches via one or more Internet-based search engines at one or more pre-vetted websites, and obtaining search results;
evaluating the search results based upon a predetermined criteria and selecting an optimal search for each question based upon the evaluation;
creating a linkage between each of the questions and each optimal search that is determined for each question;
storing the list of questions, the linkages, and the optimal searches as a data structure in a data storage device; and
making the data structure or portions of the data structure available and accessible to a user at a mobile device.

20. A method of retrieving and presenting a live book to a user at a mobile device, the mobile device including a memory, the method comprising:
obtaining a book selection from a user, the book selection obtained via user action at a user interface of a mobile device;
automatically retrieving from the memory an optimized search associated with the book selection made by the user;
executing the search;
receiving search results accomplished by the search;
automatically formatting the search results into a predefined viewing format;
presenting the formatted search results to the user.

21. The method of claim 20, wherein the book selection comprises a selection of a book or selection of portions of a book.

22. The method of claim 20, wherein the search is optimized according to a best Boolean search approach.

23. The method of claim 20, further comprising the book selection being selected a second time and the formatted search results being updated and presented to the user.

24. The method of claim 20, further comprising providing in the formatted search results citations to supporting materials, the citations being provided with hyperlinks.

25. The method of claim 20, further comprising providing the formatted search results as formatted text.

26. The method of claim 25, further comprising including images in the formatted text.
